(19) United States
(12) Patent Application Publication
(10) Pub. No.: US 2003/0149491 A1
(43) Pub. Date: Aug. 7, 2003

(54) System for supplying fuel to construction machine and construction machine

(76) Inventors: Hiroyuki Adachi, Tsuchiurashi (JP); Toichi Hirata, Ushikushi (JP); Genroku Sugiyama, Inashiki-gun (JP); Hiroshi Watanabe, Ushikushi (JP); Koichi Shibata, Tsuchiurashi (JP); Hideki Komatsu, Kitasouma-gun (JP)

Correspondence Address: Oliff & Berridge, PO Box 19928, Alexandria, VA, 22320, US

(21) Appl. No.: 09/980,105

(22) PCT Filed: Mar. 30, 2001
(86) PCT No.: PCT/JP01/02810

(30) Foreign Application Priority Data
Mar. 31, 2000 (JP) 2000-099087

(51) Int. Cl. G05B 15/02; G06F 17/00

(52) U.S. Cl. 700/9; 705/413

(57) ABSTRACT

A construction machine refueling system receives information transmitted from a construction machine at a receiver provided in a base station, and the construction machine includes a detector that detects a residual fuel amount and a transmitter that, when the residual amount of fuel is less than a specified value, transmits information indicating that fact to the base station.

### TECHNICAL FIELD

The present invention relates to a system for refueling a construction machine, such as a hydraulic excavator, and to a construction machine.

### BACKGROUND ART

Refueling of construction machines is currently carried out by a fuel tanker going around to each work site about once every two days or so. However, with this method, the fuel tanker is not always on site when refueling is required, and there has been a desire for a more efficient system.

Conventionally, systems for managing the in-transit status of vehicles such as cars and dump trucks have been disclosed in, for example, Japanese Laid-Open Patent Publication No. H4-174387 and Japanese Laid-Open Patent Publication No. H4-174388, but these systems do not consider any aspects of refueling.

### DISCLOSURE OF THE INVENTION

The object of the present invention is to provide a construction machine refueling system that is capable of notifying construction machine fuel shortage to a base station to enable rapid refueling, and to provide a construction machine.

In order to achieve this object, a construction machine refueling system according to the present invention comprises: a detector that is provided in a construction system and detects a residual fuel amount; and a transmitter that, when the residual fuel amount is less than a specified value, transmits information indicating that fact to the base station.

According to the present invention, a residual fuel amount is detected for individual construction machines, and if the residual fuel amount is less than a specified value that fact is notified in a transmission to a base station. This means that a reduction in fuel can be ascertained at the base station side without any special operation, enabling refueling measures to be taken. Accordingly, the operator of a construction machine can carry out their tasks without worrying about residual fuel amount, and the problem of work being interrupted due to running out of fuel will not arise.

If the residual fuel amount is less than a specified value, and information indicating the residual amount is transmitted, the order in which refueling is carried out etc. can be adjusted at the base station or tie-up station side. If positional information of the construction machines is detected and this positional information is transmitted, the position of the construction machines to be refueled can be accurately ascertained and refueling carried out reliably. If the base station is provided with a function of requesting refueling to the tie-up station based on information received by a receiver, refueling can be carried out rapidly.

Another construction machine refueling system according to the present invention comprises: a transmitter that is provided in a construction machine and transmits information relating to refueling; a receiver that is provided at a location remote from the construction machine and receives the information related to refueling transmitted from the construction machine; a selector that selects an optimum refueling location from a plurality of refueling locations based on the information received by the receiver; and a communication device that carries out communication with the refueling location selected by the selector to request refueling of the construction machine.

According to the present invention, since an optimum refueling location is selected from a plurality of refueling locations, it is possible to carry out rapid refueling, and a decrease in the costs involved with refueling can be expected.

The optimum refueling location is selected based on, for example, an residual fuel amount transmitted from the construction machine, or data in a database storing data related to the plurality of refueling locations. In particular, it is preferable to select the refueling location based on location information of the refueling locations or fuel unit cost information etc. stored in a database.

### BRIEF DESCRIPTION OF THE DRAWINGS

FIG. 1 is a schematic diagram of a refueling system of a first embodiment according to the present invention.

FIG. 2 is a flowchart showing processing flow for a hydraulic excavator of the first embodiment.

FIG. 3 is a flowchart showing processing flow for a base station of the first embodiment.

FIG. 4 is a flowchart showing processing flow for a tie-up station of the first embodiment.

FIG. 5 is a flowchart showing another example of processing flow for a tie-up station.

FIG. 6 is a flowchart showing another example of processing flow for a hydraulic excavator.

FIG. 7 is a flowchart showing another example of processing flow for a base station.

FIG. 8 is a schematic diagram of a refueling system of a second embodiment according to the present invention.

FIG. 9 is a flowchart showing processing flow for a hydraulic excavator of the second embodiment.

FIG. 10 is a flowchart showing processing flow for a base station of the second embodiment.

FIG. 11 is a flowchart showing processing flow for a gas station of the second embodiment.

FIG. 12 is a flowchart showing another example of processing flow for a gas station of the second embodiment.

### BEST MODE FOR CARRYING OUT THE INVENTION

First Embodiment

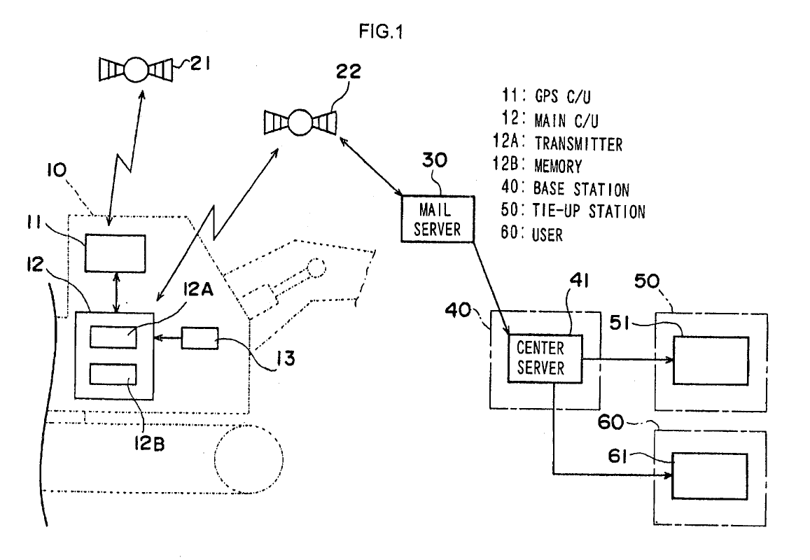

One embodiment according to the present invention will now be described using FIG. 1-FIG. 4, for the case of application to a refueling system for hydraulic excavators.

FIG. 1 is a schematic diagram of a system according to the present invention. GPS control units 11 mounted in respective hydraulic excavators 10 receive radio waves from a plurality of GPS satellites 21, and calculate location information for each hydraulic excavator 10 (a vehicle itself). This location information is input to a main control unit 12. In this example, the location information is, for example, longitude and latitude information. Detection results from a fuel sensor 13 for detecting a residual fuel amount are input to the main control unit 12. The fuel sensor 13 can be one that is conventionally provided in a hydraulic excavator 10.

The main control unit 12 has a transmission section 12A for transmitting input residual fuel amount and positional information etc., and a memory 12B for storing various information. Information transmitted from the transmission section 12A is transmitted to a specified management server through a communications satellite 22. With this embodiment, a mail server 30 is used as the management server. There are various types of transmission information, such as information representing the operating state of the hydraulic excavator 10 or failure information, as well as the positional information and fuel information described above.

On the other hand, a center server 41 is installed in the base station 40 that is far from the hydraulic excavator 10 (for example, the head office or a branch office of the construction machine company). The center server 41 is capable of taking in information transmitted from the mail server 30, and transmitting information by e-mail or the like to respective terminals 51 and 61 of the tie-up or affiliated station (for example, a gas station or a service center) 50 and a user 60, as required.

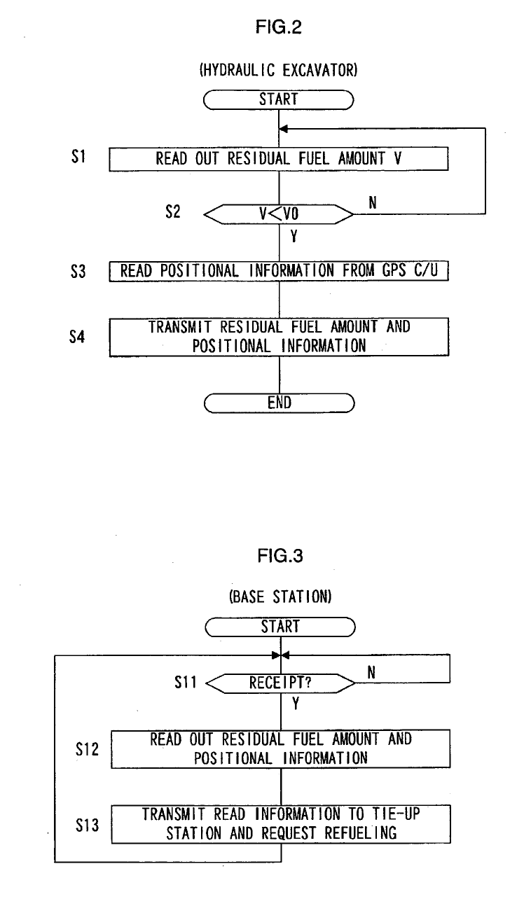

A concrete example of processing will now be described with reference to the flowcharts of FIG. 2-FIG. 4.

FIG. 2 shows processing for the main control unit 12 of a hydraulic excavator 10. For example, this program is started upon starting up the engine. A residual fuel amount V is readout from the fuel sensor 13 (step S1) and the residual fuel amount V is compared to a specified value V0 (step S2). If V<V0, it is judged that the residual fuel amount is low and so refueling is required, positional information of the hydraulic excavator 10 is read from the GPS control unit 11 (step S3), and the residual fuel amount V and the positional information are transmitted from the transmission section 12A (step S4). On the other hand, in the event that V≧V0, it is judged that the residual fuel amount is sufficient and refueling is not required, there is no transmission and processing returned to step S1.

Information transmitted from the hydraulic excavator 10 is transmitted to the mail server 30 through the communications satellite 22, as described above, and information is transmitted from the mail server 30 to the base station 40.

FIG. 3 shows processing for the center server 41 of the base station 40. In step S11 it is judged whether or not information has been received, and if information has been received, that information is read out (step S12). A request for refueling the hydraulic excavator 10 is achieved by transmitting the read out residual fuel amount V and positional information to the tie-up station 50 in an e-mail message or the like (step S13).

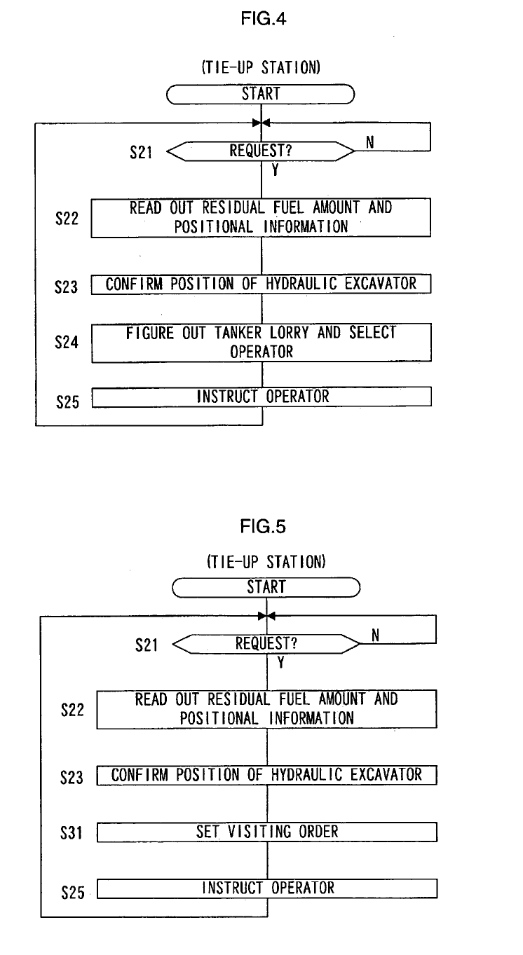

FIG. 4 shows one example of processing for the terminal 51 of the tie-up station 50. If there is a refueling request in step S21 (if an e-mail message has been received from the base station 40), this is read out (step S22) and the position of the hydraulic excavator 10 to be refueled is confirmed based on the obtained positional information. Next, a tanker lorry that is in the vicinity of that hydraulic excavator 10 is figured out or computed from the tie-up station's management data or the like, an operator is chosen (step S24) and an instruction to drive the tanker lorry to the location is output to that operator (step S25).

Also, if there are a plurality of hydraulic excavators 10 to be refueled, then as shown, for example, in FIG. 5, an order in which to go to each of the hydraulic excavators 10 is set for the tanker lorry (step S31), and an instruction to drive to each location in that order is output (step S32). The order of visiting the refueling locations is preferably set taking into consideration which route can be more efficient to travel along to most efficiently refuel each excavator. Alternatively, the order can be set so as to visit sites in order of least residual fuel amount.

According to this embodiment, if the residual fuel amount V of individual hydraulic excavators 10 is less than a specified value V0, information conveying that fact is automatically transmitted, a refueling request is output to a tie-up station 50 from a base station 40 receiving that information, and refueling is practically carried out by that tie-up station 50. Accordingly, the operator of a hydraulic excavator 10 can carry out operations without having to worry particularly about the residual fuel amount, and the problem of work being interrupted due to running out of fuel will not arise.

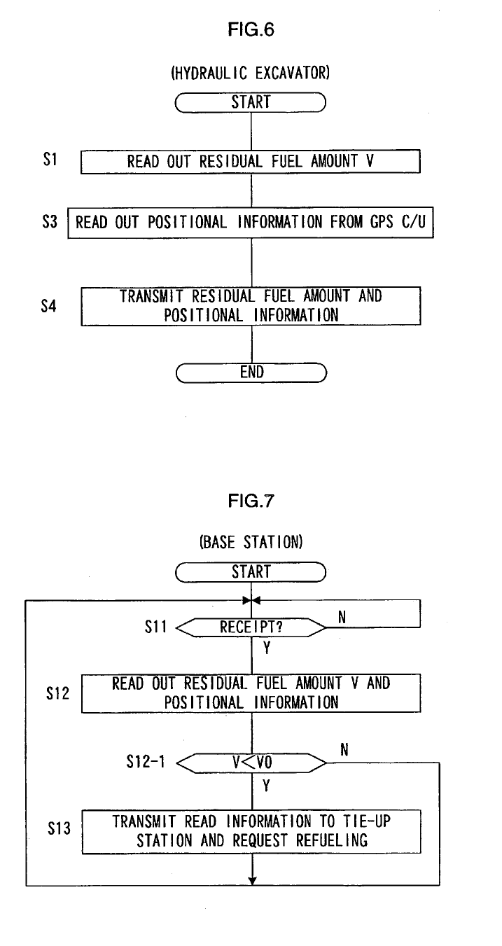

In the description above, a decision as to whether or not the residual fuel amount is less than a specified value is made at the hydraulic excavator 10 side, but an example where this decision is made at the base station 40 side is shown in FIG. 6 and FIG. 7. The same step numbers are affixed to steps that are the same as in FIG. 2 and FIG. 3.

In FIG. 6, the main control unit 12 of the hydraulic excavator 10 transmits residual fuel amount V and positional information regardless of what the residual fuel amount actually is. In FIG. 7, the center server 41 of the base station 40 compares the residual fuel amount V to a specified value V0 (step S12-1) after the above described processing of step S12, and if V<V0, it is judged that the there is only a little fuel remaining and so refueling is required, and issues a refueling request (step S13). On the other hand, if V>V0, it is judged that the residual fuel amount is sufficient and refueling is not required, and a refueling request is not issued. It is also possible to realize the same operational effects as described above with this structure.

With the embodiment of FIG. 2, residual fuel amount is transmitted from the hydraulic excavator 10, but it is also possible to transmit information indicating that the residual fuel amount is low. Also, it is not essential to transmit positional information. Specifically, when transmitting information, if an ID number identifying or designating that hydraulic excavator 10 is also transmitted, the approximate position of the hydraulic excavator 10 is ascertained on the base station side based on this ID number, and the base station can also deal with notifying the tie-up station about this positional information.

Second Embodiment

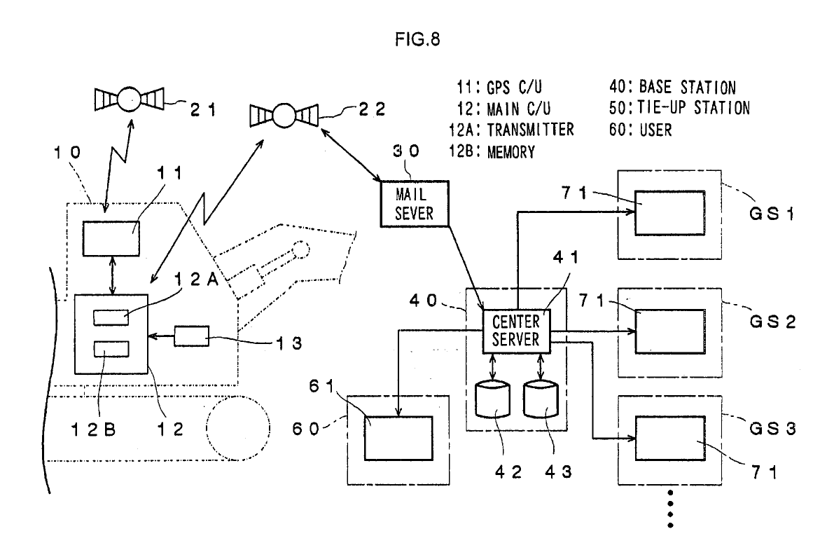

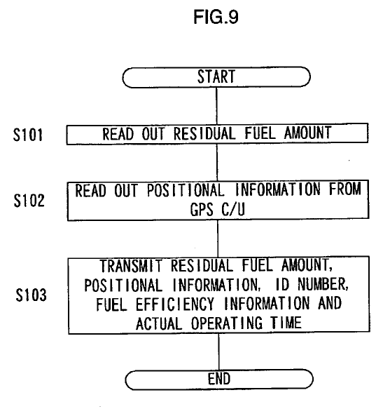

A second embodiment according to the present invention will now be described using FIG. 8-FIG. 12.

With this embodiment, if the need for refueling arises in a hydraulic excavator 10, an optimum gas station is selected from a plurality of gas stations, and a request for refueling is sent to this selected gas station.

FIG. 8 is a schematic diagram of this embodiment, and the same reference numerals are affixed to structural components that are the same as in FIG. 1.

A center server 41 of a base station is capable of sending information in e-mail messages or the like to terminals 71 of a plurality of gas stations (GS1, GS2, GS3, . . . , but in the following they will be collectively referred to as GS). A data base 42 storing information for different types of hydraulic excavator 10, and a data base 43 for storing information relating to the plurality of gas station GS are also provide in the base station 40. The center server 41 reads out-information from the databases 42 and 43, and appends information to the databases, as required.

Next, the control content of this embodiment will be described.

FIG. 9 shows processing for the main control unit 12 of a hydraulic excavator 10.

For example, a program is initiated upon starting the engine, and residual fuel amount V is read out from the fuel sensor 13 (step S101) and positional information of the hydraulic excavator 10 is read out from the GPS control unit 11 (step S102). Then, in addition to the residual fuel amount V and the positional information, an ID number of that hydraulic excavator 10, fuel efficiency (gas mileage) information and actual operating time are transmitted from the transmission section 12A (Step S103).

Here, fuel efficiency information for a previous actual result value is calculated by the main control unit 12. Also, the actual operating time is a time measured by a timer provided in the hydraulic excavator 10.

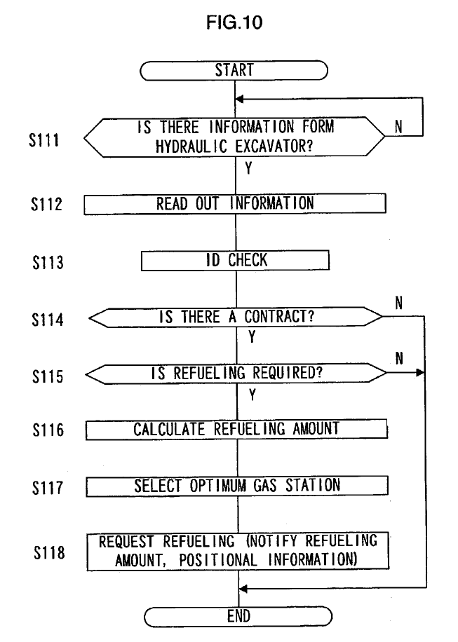

FIG. 10 shows processing carried out by the center server 41 of the base station 40.

It is judged whether or not information has been received from the hydraulic excavator 10 (Step S111), and if information has been received, that information is read out (step S112). An ID number within the read out information is checked (step S113), and based on that ID number it is judged whether or not it is a hydraulic excavator 10 with a refueling service contract (step S114). If they have a contract, it is judged, based on the residual fuel amount, whether or not refueling is required (step S115). If refueling is required, the amount of fuel required is calculated (step S116). The amount of fuel required in the refueling is calculated based on the residual fuel amount transmitted from the hydraulic excavator 10, and fuel tank capacity information obtained from the database 42 storing type of machine information, etc. Next, an optimum gas station to send the refueling request to is selected from the plurality of gas stations GS (step S117).

This selection of the optimum gas station is carried out by extracting data such as location of each gas station, fuel cost, and transportation costs required for refueling from the database 43 storing data relating to the plurality of gas stations, and referring to these items of data. Basically, a gas station GS that has low fuel costs and transportation costs, and that is in the vicinity of the work site (the position of the hydraulic excavator 10), is selected. For example, it is possible to give priority to “proximity to work site” in the event that residual fuel amount is low, and to give priority to “cheapness of unit costs and transportation costs” in the event that the residual fuel amount is comparatively high. It is also possible to select the optimum gas station with reference to traffic information for supply roads (traffic jam information, whether or not there are road repairs, etc.).

The above described gas station selection is designed to be efficient by using dedicated software, but it is also possible to carry out selection by an operator performing a judgment based on various conditions.

If the optimum gas station is determined, a refueling request is sent to that gas station GS in an e-mail message, for example. At this time, the position (based on information transmitted from the hydraulic excavator 10) and residual fuel amount (the value calculated in step S116) for the hydraulic excavator 10 to be refueled are known.

FIG. 11 shows processing carried out by terminal 71 of the gas station GS.

It is judged whether or not there is a refueling request from the base station 40 (Step S121), and if there is a refueling request, an instruction is output to a tanker lorry. which is then refueled (step S122). In the event there are a number of hydraulic excavators 10 to be refueled, then similarly to the above described embodiment, an order for driving around to the hydraulic excavators 10 is set for the tanker lorry, and an instruction to drive to each location in that order is output.

Upon completion of refueling, information about the residual fuel amount and the time and date of refueling (refueling information) are transmitted to the gas station GS. It is also possible to transmit, for example, from the hydraulic excavator 10 that has been refueled through the base station, or to contact from the tanker lorry doing the refueling.

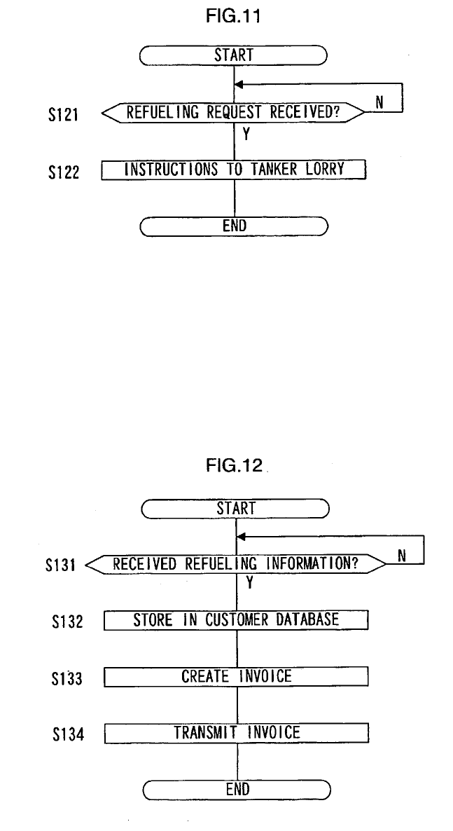

FIG. 12 shows processing carried out by the terminal 71 of the gas station GS after fuel has been supplied.

It is judged whether or not the above described refueling information has been received (step S131), and if the information has been received, data such as residual fuel amount and time and date of refueling are stored in a customer database (step 132). Also, an invoice is created based on the refueling information (step S133) and this invoice is sent to the customer as an electronic mail message or the like.

This sequence of processes to receive the information, create the invoice and transmit the invoice is preferably automatically carried out using dedicated invoice creating software.

With this embodiment as described above, an optimum gas station is selected from a plurality of gas stations, and a request for refueling is sent to this optimum gas station, which means that rapid refueling is carried out without delay at the time it is required, and reduction in the costs required for refueling can be expected. Also, since an invoice is created by receiving transmitted refueling information and then transmitted to a customer, the operating efficiency of each gas station can be expected to improve.

The future refueling time for each individual hydraulic excavator 10 is predicted by the base station 40, and it is possible to carry out refueling processing based on this prediction. Specifically, information such as fuel efficiency information and actual operating time are transmitted from the hydraulic excavator 10 as described above. Fuel reduction rates are then calculated by the center server 41 of the base station 40 from the actual operating time and the fuel efficiency, and the future refueling time for that hydraulic excavator 10 is estimated. This refueling time is stored in a database for each individual hydraulic excavator. If this refueling time is being reached, an optimum gas station is selected by the same method as described above and a request for refueling is issued.

Also, similarly to the examples shown in FIG. 2 and FIG. 3, it is possible to judge whether or not refueling is required at the hydraulic excavator side, and to carry out processing at the base station side based on the result of that judgment.

With the above described first and second embodiments, the position of the hydraulic excavator 10 is detected using a GPS satellite, but it is also possible to use, for example, a PHS positional information providing service or the like instead. Also, the base station is not limited to a construction machine manufacturer, and can also be a construction machine rental company.

### INDUSTRIAL APPLICABILITY

A description has been given above for a system for refueling hydraulic excavators, but the present invention can also be applied to a system for refueling construction machines other than hydraulic excavators (for example, cranes or the like).

1. A construction machine refueling system for receiving information transmitted from a construction machine at a receiver provided in a base station, the construction machine comprising:
a detector that detects a residual fuel amount; and
a transmitter that, when the residual fuel amount is less than a specified value, transmits information indicating a fact that the residual fuel amount is less than a specified value, to the base station.

2. A construction machine refueling system according to claim 1, wherein
said transmitter transmits information representing the residual fuel amount when the residual fuel amount is less than a specified value.

3. A construction machine refueling system according to claim 1 or claim 2, wherein:
said construction machine is further provided with a positional information detector that detects positional information of the construction machine; and
said transmitter also transmits the detected positional information when transmitting.

4. A construction machine refueling system according to any one of claim 1 through claim 3, further comprising:
a base station side transmitter that is provided at the base station side and transmits a request of refueling based on information received by the receiver, to a tie-up station.

5. A construction machine refueling system according to any one of claim 1 through claim 3, further comprising:
a base station side transmitter that is provided at the base station side and transmits information received by the receiver to a user side receiver that is provided at a user side of the construction machine.

6. A construction machine refueling system for receiving information transmitted from a construction machine at a receiver provided in a base station, wherein:
the construction machine comprises a detector that detects residual fuel amount, and a transmitter that transmits the residual fuel amount detected by the detector to the base station; and
the base station comprises a determination unit that determines whether or not the received residual fuel amount is lower than a specified value.

7. A construction machine, comprising:
a detector that detects a residual fuel amount; and
a transmitter that, when the residual fuel amount is lower than a specified value, transmits information indicating a fact that the residual fuel amount is lower than a specified value, to a base station.

8. A construction machine refueling system, comprising:
a transmitter that is provided in a construction machine and transmits information relating to refueling;
a receiver that is provided at a place far from the construction machine and receives the information relating to refueling transmitted from the construction machine;
a selector that selects an optimum refueling location from a plurality of refueling locations based on information received by the receiver; and
a communications device that carries out communication with the refueling location selected by said selector to send a request for refueling of the construction machine.

9. A construction machine refueling system, comprising:
a receiver that receives information relating to refueling transmitted from a construction machine at a distant place;
a selector that selects an optimum refueling location from a plurality of refueling locations based on information received by the receiver; and
a communications device that carries out communication with the refueling location selected by the selector to send a request for refueling of the construction machine.

10. A construction machine refueling system according to claim 8 or claim 9, wherein said selector selects the optimum refueling location based on a residual fuel amount transmitted from the construction machine.

11. A construction machine refueling system according to claim 8 or claim 9, wherein said selector reads out data relating to the plurality of refueling locations from a specified database, and selects the optimum refueling location based on the read out data.

12. A construction machine refueling system according to claim 11, wherein said selector selects the optimum refueling location based on location information for the refueling locations read out from the database.

13. A construction machine refueling system according to claim 11, wherein said selector selects the optimum refueling location based on fuel unit cost information for the refueling locations read out from the database.

14. A construction machine refueling system, comprising:
a transmitter that transmits refueling information including an amount of fuel to be supplied to a construction machine;
a receiver that receives the transmitted information;
an invoice creating unit that creates an invoice based on the information received by the receiver; and
a transmitter that transmits the created invoice to a customer.

15. A construction machine refueling system according to claim 14, wherein the transmitter is provided in the construction machine.
